(19) United States
(12) Patent Application Publication
(10) Pub. No.: US 2003/0140120 A1
(43) Pub. Date: Jul. 24, 2003

(54) Method and apparatus for network access

(76) Inventor: Alex James Hartman, New South Wales (AU)

Correspondence Address: Mark R Wisner, Wisner & Associates, Suite 930, 2925 Briarpark, Houston, TX, 77042-3728, US

(21) Appl. No.: 10/149,033

(22) PCT Filed: Dec. 1, 2000
(86) PCT No.: PCT/AU00/01485

(51) Int. Cl. G06F 15/16

(52) U.S. Cl. 709/219

(57) ABSTRACT

A system and method for providing user access to a network. The system includes a client computer executing a resident client application. The client application presents a user interface which facilitates browser access to a plurality of network sites, and the client application presents the user interface in accordance with a user profile which defines characteristics of the user interface. The system further includes a server which executes a resident server application. The server application can communicate with the client application, and stores and alters the user profile. The user profile and alterations of the user profile are communicated by the server to the client application. Client and server applications corresponding to the system are also provided.

### FIELD OF THE INVENTION

The present invention relates to network access, and in particular to user access to the internet

### DESCRIPTION OF THE PRIOR ART

The internet is a well known network of increasing popularity. Many people have a desire to use the internet, but are daunted by the cost and complexity of the equipment and software which is required in order to do so. Further, users must arrange internet access, for example with an Internet Service Provider (ISP).

Software applications currently exist which, once an internet connection has been established via the ISP, allow the user to access and view internet sites written in HTML or other codes. Such applications are known as browsers, and must be purchased by users from software providers.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The preceding description in no way constitutes an admission of the common general knowledge of a person skilled in this field.

### SUMMARY OF THE INVENTION

According to a first aspect, the present invention resides in a system for providing user access to a network, including:

client computing means executing a resident client application, the client application presenting a user interface facilitating browser access to a plurality of network sites, the user interface being presented in accordance with a user profile which defines characteristics of the user interface; and

server computing means executing a resident server application, the server application operable to communicate with the client application, to store the user profile, to alter the user profile, and to communicate the user profile and alterations of the user profile to the client application.

According to a second aspect the present invention provides a client application for residing on client computing means and for providing user access to a network

wherein the client application is operable to receive a user profile which is stored by a server application and which defines characteristics of a user interface,

wherein the client application is operable to receive alterations of the user profile,

and wherein the client application is operable to present the user interface in accordance with the user profile, the user interface facilitating browser access to a plurality of network sites.

According to a third aspect the present invention provides a server application for residing on server computing means and for facilitating user access to a network,

wherein the server application is operable to store a user profile defining characteristics of a user interface, the user interface facilitating browser access to a plurality of network sites,

wherein the server application is operable to alter the user profile, and

wherein the server application is operable to communicate the user profile and alterations of the user profile to a client application resident on and executed by client computing means, for presentation of the user interface by the client application.

By using a server application to store and alter a user profile defining a user interface, the present invention provides a number of advantages. These include enabling a company or entity controlling the server application to alter the user interface, for example to change graphic design of the user interface, to improve or alter the functionality of the user interface, to allow for new network capabilities or network sites which may arise after creation of the user interface, or to alter or add advertising to be presented with the user interface. Further, the ability to alter the user interface can provide a user interface which is up to date. Additionally, the use of the server application to store the user profile may enable user devices of limited capacity, such a WAP enabled mobile phones, personal digital assistants, wireless devices and the like, to access a network such as the internet without the need to store potentially large amounts of information.

It will be appreciated that the server application could be provided by a company or entity which does not provide internet access services to the user of the client application For example, the server application may be installed at a ‘home’ site of the client application, namely a network site first accessed by the client application upon accessing the network.

However, in embodiments of the invention where the network is the internet and an ISP provides user access to the internet, the ISP preferably also hosts the server application in accordance with the present invention. Such embodiments of the invention enable convenient communication between the server application and the client application, as the ISP is contacted whenever user access to the internet is required. Further, commercial opportunities made available to the ISP may be significantly increased, for example by enabling the ISP, beyond its basic role of internet access provider, to target and then deliver rich content and services to a user, along with the option of advertising. The presentation of the user interface by the client application provides an opportunity to increase user awareness of the ISP, along with opportunities for the ISP to provide value-added services, support services, application rental, e-commerce or subscription content services. Additionally, the storage of a user profile by an ISP in such embodiments may enable the ISP to access previously unavailable customer information, and hence market information.

Accordingly, in preferred embodiments of the invention, the client application and/or server application is/are operable to undertake click-stream analysis of use of the user interface. The data obtained by click-stream analysis may be advantageous to the user, in that the server application may alter the user profile to best meet a user's typical usage patterns. The data obtained by click-stream analysis may also be advantageous to the entity operating the server application (such as an ISP) in obtaining customer information, and enabling targeted advertising to occur.

In preferred embodiments of the invention, the client application is operable to present one of a plurality of user interfaces based on a corresponding one of a plurality of user profiles. In such embodiments, the user interface which is presented may be dependent on the identity of a user. The identity of the user may be established by a routine login procedure performed by the client application. Alternatively, the user interface displayed may be dependent on the date and/or time, or on other factors. For example a choice of user interface to display may be performed depending on the day of the week, for example where television programming advertisements are displayed, or may be performed depending on time of year, for example where seasonal sporting advertisements or clothing advertisements are to be displayed by the user interface.

In preferred embodiments of the invention, the server application is operable to store a plurality of user profiles. ISPs and server sites typically have a plurality of users, and so it is desirable for the server application to accommodate a plurality of user profiles. Further, such embodiments can enable analysis of a wide customer base to be performed. Accordingly, in such embodiments the server application is preferably further operable to analyse the plurality of user profiles and, preferably, operable to define a characteristic of a first user profile by analysis of a corresponding characteristic of each of the plurality of user profiles. Such embodiments allow problems or improvements encountered by one or more users to be solved or implemented for all users, rather than individually for each user.

The user profile may define characteristics of the user interface such as visible attributes of the user interface, or functional attributes defining a manner of operation of the client application in presenting the user interface. For example, the user profile may define graphic design features of the user interface, a size and shape of the user interface, and/or a desired location of the user interface on a user display. The user profile may define components of the user interface, such as the visual appearance of one or more buttons in both inactivated and activated states.

Further, the user profile may consist of user-defined portions and server-defined portions.

Preferably, the client application cooperates with a network browser to present network content to a user. For example, a user may select options presented by the user interface, upon which the client application instructs the browser to access and display network content accordingly. In such embodiments, the user interface may appear simply as a ‘toolbar’on the user's display, overlying a whole-screen or whole-frame browser operating in conventional manner. Such embodiments are particularly advantageous in that the client application can be relatively small and therefore require relatively little memory and storage resources of a client computing means. Hence, users and service providers obtain the advantage of an alterable user profile while causing relatively little additional operational load on the client computing means. Alternatively, the client application itself may have network browser capabilities.

In some embodiments of the invention, alterations of the user profile may be communicated to the client application upon alteration of the user profile. Such embodiments allow alterations of the user profile to be made dynamically, while the client application is operating, allowing the server application to alter the appearance and content of the user interface at any time. Alternatively, alterations of the user profile may be communicated to the client application upon commencement of communication between the user application and the server application.

In some embodiments of the invention, the server application may be operable to communicate the user profile and alterations of the user profile to the client application, even when the client application is performing browser access to network sites which do not interact with the server application. For example, while a user performs browser access to such network sites, the server application may communicate alterations of the user profile to the client application, which may dynamically update the user interface in accordance with the alterations, without the need for interrupting the user's enjoyment of browsing. Alternatively, the server application may only be able to communicate alterations of the user profile to the client application when browser access to a network site which interacts with the server application is performed. Of course, once such alterations are communicated, browser access to other network sites may continue, with the user interface updated in accordance with the alterations.

The client application may be operable to provide user access to more than one network, for instance internet access and local area network access.

The server application is preferably further operable to perform one or more of the following: provide authentication and session management services to one or more client applications; provide messaging to one or more client applications; communicate an updated client application to replace an existing client application; export collected usage data to warehousing facilities; and provide industry standard interfaces for operational monitoring and management.

According to a fourth aspect the present invention resides in a method for providing user access to a network, including the steps of:

receiving at a client site a user profile which defines characteristics of a user interface;

presenting at the client site a user interface in accordance with the user profile, the user interface facilitating browser access to a plurality of network sites;

storing the user profile at a server site;

altering the user profile at the server site; and

communicating the user profile and alterations of the user profile to the client site.

According to a fifth aspect the present invention resides in a method of providing user access to a network at a client site, including the steps of:

receiving at the client site a user profile which defines characteristics of a user interface and which is stored at a server site;

receiving at the client site alterations of the user profile; and

presenting a user interface in accordance with the user profile, the user interface facilitating browser access to a plurality of network sites.

According to a sixth aspect the present invention resides in a method of facilitating, from a server site, user access to a network, the method including the steps of:

storing at the server site a user profile defining characteristics of a user interface, the user interface facilitating browser access to a plurality of network sites;

altering the user profile; and

communicating the user profile and alterations of the user profile to a client site for presentation of the user interface.

Embodiments of the fourth and sixth aspects of the invention preferably further include the step of performing, at the server site, click-stream analysis of use of the user interface.

In embodiments of the fourth and fifth aspects of the invention, the step of presenting preferably includes presenting one of a plurality of user interfaces based on a corresponding one of a plurality of user profiles. The step of presenting may be dependent upon the identity of a user. Accordingly, embodiments of the fourth, fifth and sixth aspects of the invention may include the further step of establishing the identity of a user, which may be performed by routine login procedures.

In embodiments of the fourth and sixth aspects of the invention, the step of storing preferably includes storing a plurality of user profiles. Such embodiments may include the further step of defining a characteristic of a first user profile by analysis of a corresponding characteristic of each of the plurality of user profiles.

In embodiments of the fourth and sixth aspects of the invention, the step of communicating alterations of the user profile may be performed upon completion of said alterations. Alternatively, the step of communicating alterations of the user profile may be performed upon establishment of network access by a user.

Embodiments of the fourth and sixth aspects of the invention may include one or more of the following steps:

providing authentication and session management services to one or more client applications;

providing messaging to one or more client applications;

communicating an updated client application to replace an existing client application;

exporting collected usage data to warehousing facilities; and

providing industry standard interfaces for operational monitoring and management.

According to a seventh aspect, the present invention resides in a system for providing user access to a network, including:

client computing means operating under the control of a client application, the client application presenting a user interface in accordance with a user profile which defines characteristics of the user interface, the user interface facilitating network access; and

server computing means operating under the control of a server application, the server application operable to communicate with the client application, to store the user profile, to alter the user profile, and to communicate the user profile and alterations of the user profile to the client application.

According to an eighth aspect the present invention resides in a client application for providing user access to a network,

wherein the client application is operable to receive a user profile which defines characteristics of a user interface and which is stored by a server application,

wherein the client application is operable to receive alterations of the user profile,

and wherein the client application is operable to present the user interface in accordance with the user profile, the user interface facilitating network access.

According to a ninth aspect the present invention provides a server application for facilitating user access to a network,

wherein the server application is operable to store a user profile defining characteristics of a user interface,

wherein the server application is operable to alter the user profile, and

wherein the server application is operable to communicate the user profile and alterations of the user profile to a client application for presentation of the user interface.

According to a tenth aspect, the present invention resides in a system for providing user access to a network, comprising:

client computing means executing a resident client application, the client application presenting a user interface, the user interface operable to facilitate non-browser access to a plurality of network sites and to facilitate browser access to a plurality of network sites, the user interface being presented in accordance with a user profile which defines characteristics of the user interface; and

server computing means executing a resident server application, the server application operable to communicate with the client application, to store the user profile, to alter the user profile, and to communicate the user profile and alterations of the user profile to the client application.

According to an eleventh aspect the present invention provides a client application for residing on client computing means and for facilitating user access to a network,

wherein the client application is operable to receive a user profile which is stored by a server application and which defines characteristics of a user interface,

wherein the client application is operable to receive alterations of the user profile,

and wherein the client application is operable to present the user interface in accordance with the user profile, the user interface facilitating non-browser access to a plurality of network sites, and facilitating browser access to a plurality of network sites.

According to a twelfth aspect, the present invention provides a server application for residing on server computing means and for facilitating user access to a network,

wherein the server application is operable to store a user profile defining characteristics of a user interface, the user interface facilitating non-browser access to a plurality of network sites and facilitating browser access to a plurality of network sites,

wherein the server application is operable to alter the user profile, and

wherein the server application is operable to communicate the user profile and alterations of the user profile to a client application resident on and executed by client computing means, for presentation of the user interface by the client application.

While preferred embodiments of the invention work in conjunction with a browser to facilitate user access to a plurality of network sites, it is to be appreciated that the client application is independent of such a browser, and presents the user interface without assistance from such a browser.

Embodiments of the tenth, eleventh and twelfth aspects of the invention facilitate non-browser access to a plurality of network sites, and therefore facilitate user access to a plurality of network sites without the need for operation of a browser application. For example, the user interface may facilitate non-browser user access to network sites such as news tickers, email services, data resources and the like.

At times at which the user interface is facilitating non-browser access only, it is therefore unnecessary to operate a separate browser application, thereby avoiding the attendant complexities of operation and computing load associated with such a browser application.

### BRIEF DESCRIPTION OF THE DRAWINGS

Examples of the invention will now be described with reference to the accompanying drawings in which:

FIG. 1 illustrates a system for providing user access to a network in accordance with the present invention;

FIG. 2 illustrates another system for providing user access to a network in accordance with the present invention;

FIG. 3 illustrates a user interface of a server application in accordance with the present invention;

FIG. 4 illustrates a primary toolbar of a user interface presented by a client application in accordance with the present invention;

FIG. 5 illustrates a tips frame appearing upon start-up of a client application in accordance with the present invention;

FIG. 6 illustrates a first submenu of the primary toolbar of the user interface of FIG. 4;

FIG. 7 illustrates a login procedure performed by the client application;

FIG. 8 illustrates a second submenu of the primary toolbar of the user interface of FIG. 4;

FIG. 9 illustrates a third submenu of the primary toolbar of the user interface of FIG. 4;

FIG. 10 illustrates a frame accessible via the user interface of FIG. 4;

FIG. 11 illustrates a fourth submenu of the primary toolbar of the user interface of FIG. 4;

FIG. 12 illustrates a fifth submenu of the primary toolbar of the user interface of FIG. 4;

FIG. 13 illustrates a sixth submenu of the primary toolbar of the user interface of FIG. 4;

FIG. 14 illustrates a news ticker of the primary toolbar of the user interface of FIG. 4;

FIG. 15 illustrates a seventh submenu of the primary toolbar of the user interface of FIG. 4;

FIG. 16 illustrates the primary toolbar of FIG. 4 and a secondary toolbar of the user interface presented by the client application;

FIG. 17 illustrates a submenu of the secondary toolbar indicating other available secondary toolbars;

FIG. 18 illustrates a first frame of the user interface for editing characteristics of the user profile;

FIG. 19 illustrates a second frame of the user interface for editing characteristics of the user profile;

FIG. 20 illustrates a third frame of the user interface for creating, editing and deleting user profiles;

FIG. 21 illustrates a chat application supported by some embodiments of the invention;

FIG. 22 illustrates an online wallet application supported by some embodiments of the invention;

FIG. 23 illustrates a media player application supported by some embodiments of the invention; and

FIG. 24 illustrates an embodiment of the invention in which the client application provides browser capability.

### DETAILED DESCRIPTION OF THE PREFERRED EMBODIMENTS

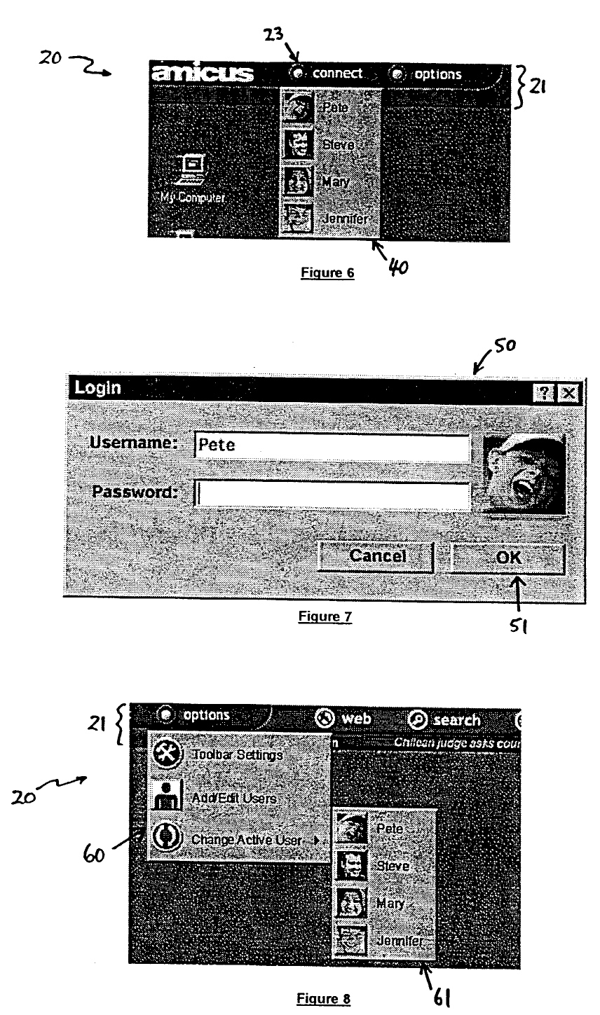

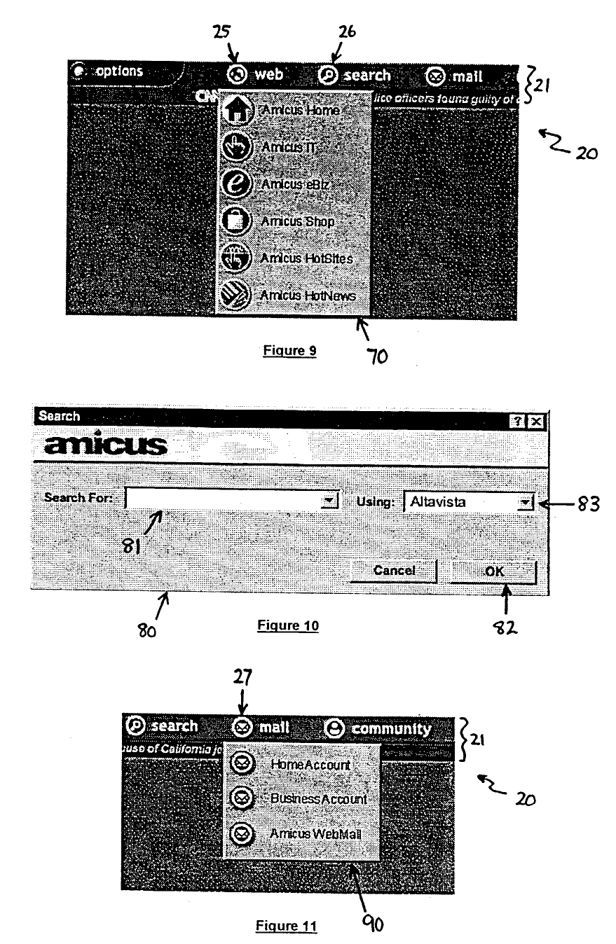

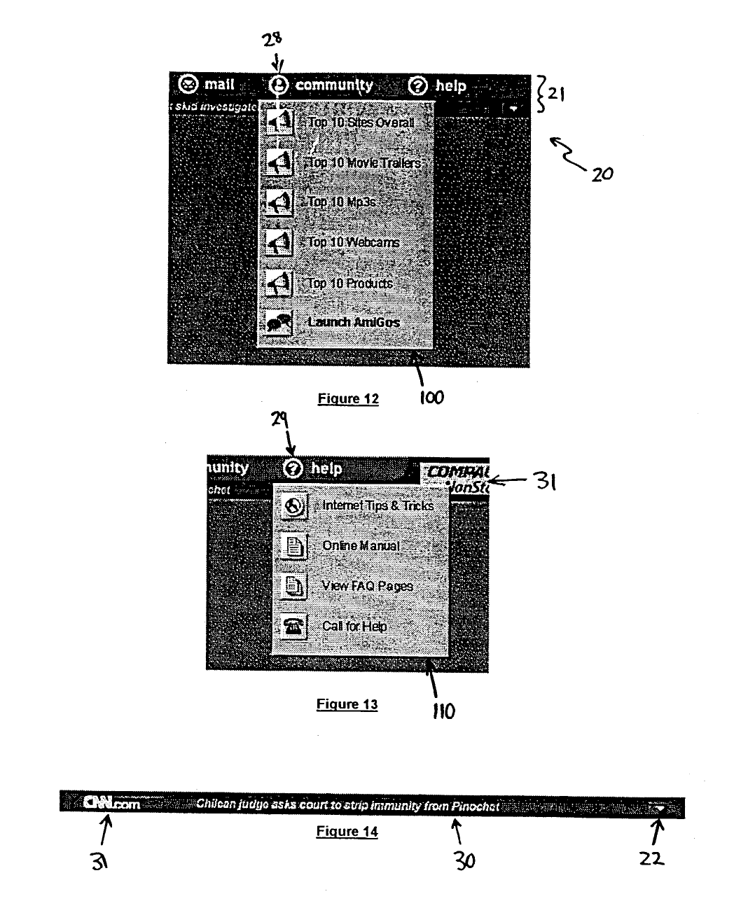

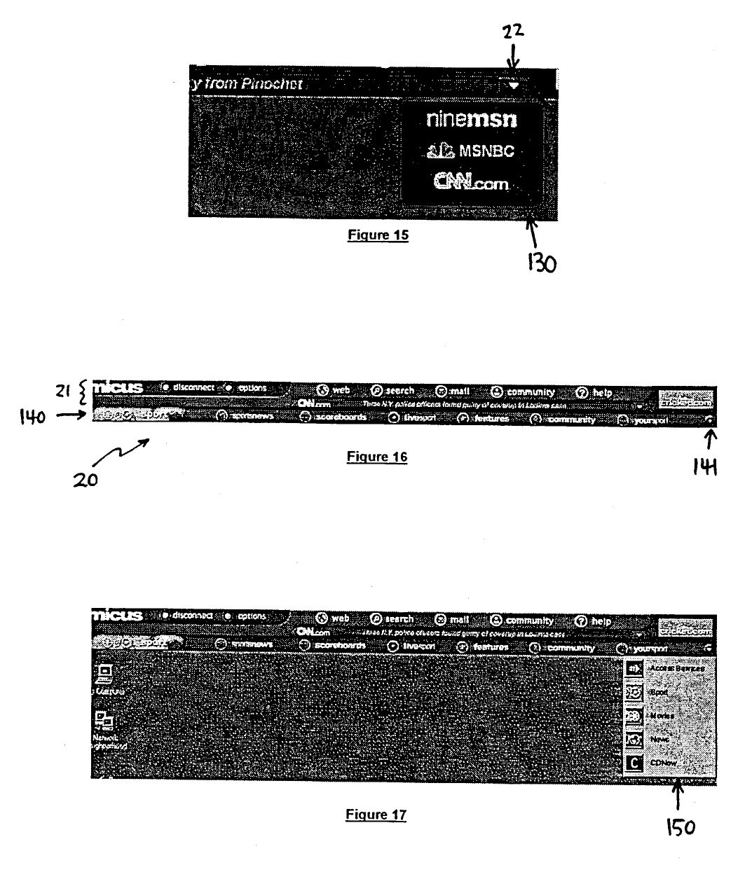

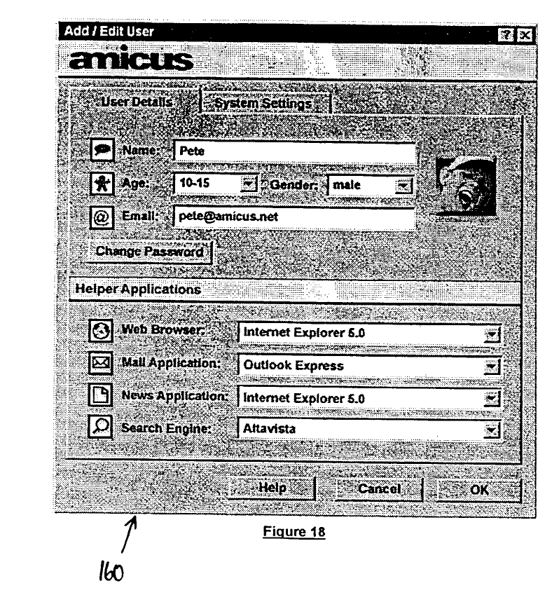

FIG. 1 illustrates a system 10 for providing user access to a network in accordance with the present invention. The system 10 includes a client computer 11 operating under the control of a client application. The client application presents a user interface on computer 11 in accordance with a user profile which defines characteristics of the user interface, the user interface facilitating user access to the internet 12. The client application is discussed in more detail with regard to FIGS. 4 to 24.

System 10 further includes a primary server 13 operating under the control of a server application. The server application can store and alter the user profile, and communicates with the client application on computer 11 via the internet 12. Furthermore, primary server 13 is operable to store a plurality of profiles for a plurality of users, and to communicate with the plurality of users via the internet 12. For simplicity, only one client computer is shown in FIG. 1. It will be appreciated that, in the following description, where reference is made to a single client computer, a plurality of client computers may be supported by the present invention. An operations console is resident on primary server 13, allowing performance monitoring. The operations console is discussed in more detail below.

System 10 further includes an administration console 14, a test server 15 and a backup server 16, which can communicate with each other and with the server computing means 13 via local area network 17. In the present embodiment, LAN 17 and servers 13, 14, 15 and 16 are all provided by an Internet Service Provider (ISP). The backup server 16 should be configured to support the primary server 13 in case of failure. In the present embodiment, the backup server 16 uses the same server software and supports the same functionality, with a different IP address.

System 10 further includes an advertising server 18 for storing advertising material to be displayed on the client computer 11. In the present embodiment, the advertising server 18 is a third party server located elsewhere and accessible via the internet, however it will be appreciated that the advertising server may be provided, for example, by the same entity providing primary server 13. Advertising features provided by advertising server 18 conform to Internet Advertising norms.

System 10 is further operable to gather data for the purposes of click-stream monitoring, which in the present embodiment is stored on a separate server, referred to here as a click-stream server 19. Such data can thereafter be viewed and analysed by ISP staff to analyse usage trends and help design appropriate changes to future versions of the system 10 and of client and server applications in accordance with the present invention. A click stream of course is the series of clicks performed by a user in the process of using software.

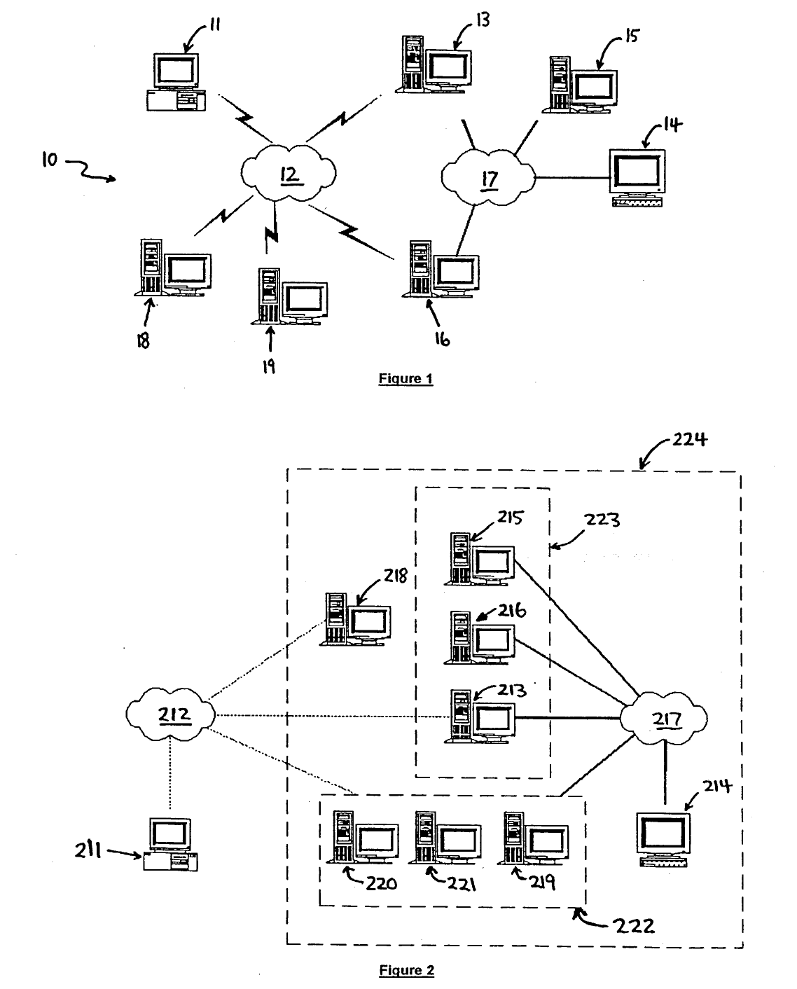

FIG. 2 illustrates a second system in accordance with the present invention. System 210 includes corresponding features to FIG. 1, arranged in an alternate fashion. Client computer 211 executes a resident client application which presents a user interface on computer 211 in accordance with a user profile which defines characteristics of the user interface, the user interface facilitating user access to the internet 212.

System 210 further includes a primary server 213 operating under the control of a server application. The server application can store and alter the user profile, and communicates with the client application on computer 211 via the internet 212. Furthermore, primary server 213 is operable to store a plurality of profiles for a plurality of users, and to communicate with the plurality of users via the internet 212. For simplicity, only one client computer is shown in FIG. 2. It will be appreciated that, in the following description, where reference is made to a single client computer, a plurality of client computers may be supported by the present embodiment. An operations console is resident on primary server 213, allowing performance monitoring. The operations console is discussed in more detail below.

System 10 further includes an administration console 214, a test server 215 and a backup server 216, which can communicate with each other and with the server computing means 213 via local area network 217. The backup server 216 should be configured to support the primary server 213 in case of failure. In the present embodiment, the backup server 216 uses the same server software and supports the same functionality, with a different IP address.

System 210 further includes an advertising server 218 for storing advertising material to be displayed on the client computer 211. Advertising features provided by advertising server 218 conform to Internet Advertising norms.

System 210 is further operable to gather data for the purposes of click-stream monitoring, which in the present embodiment is stored on a separate server, referred to here as a click-stream server 219. Such data can thereafter be viewed and analysed by ISP staff to analyse usage trends and help design appropriate changes to future versions of the system 210 and of client and server applications in accordance with the present invention. Similarly, URL data can be uploaded to the URL Server 221. The Usage Server 220 lets Service Provider staff check how many active Client Users have logged on to their server in the current and previous months. Together, the usage server 220, URL server 221 and click-stream server 219 form a Data collection server 222.

Similarly, the test server 215, backup server 216 and primary server 213 form a central server 223, which is provided by a single ISP, as are servers 218, 214, 222 and LAN 217.

The nature of the primary server 13 and administration console 14 of FIG. 1 will now be described in more detail. It will be appreciated that the following description is also applicable to system 210 of FIG. 2.

The primary server 13 executes a resident server application. In the present embodiment, the server application is a ‘faceless’ (i.e. non-GUI) application, which supports interaction between client applications and server applications, providing a host of services and interfaces to third-party systems. Once installed, the server application of the present embodiment runs automatically whenever the server is on.

The server application of the present embodiment handles the bulk of operational tasks required by client applications and by the administration c 14 console. These include authentication of clients, distribution of client version updates, management of client user profiles, management of client configuration data, message distribution, distribution of advertising content, and collection of usage data. These tasks are described in more detail below.

The server application authenticates each user, every time the client application connects to the Internet via the ISP. Users are authenticated so that the server application can ensure it sends the correct configuration data, advertising streams, and content streams to the client application of that user. The server application records all authentication attempts as part of its usage information.

The server application acts as a central repository and undertakes distribution of the latest versions of a client application for all supported platforms. The server application acts to ensure that all client applications are maintained at the latest version. When necessary, it distributes updated client software for existing client application installations to ‘update themselves’.

The server application may also act as a central repository for all user profiles for all user accounts. This feature, in combination with the server application's management of configuration data, will allow users to move from one client application installation to another, and immediately have access to their ‘personalised version’ of the user interface.

The server application may also act as a central repository for some or all client configuration data. It may contain configuration data for all Profiles and all individual user profiles. Once a client application has been successfully authenticated, it is sent any changes to the configuration data that apply to the currently active user profile. These changes to the configuration data for the user profile may have been made by ISP staff (for example via the administration console 16), or made automatically by the server application or administration console 14.

If the ISP has chosen to configure advertising space into the configuration data of client applications (for example via one or more advertising display buttons on a user interface), then the server application may provide the advertising content which will appear in that space to client applications. In such embodiments, the server application receives the advertising content for distribution from an external source (which may, for example, be the advertising server 18, or may be a manual process) through an advertising content interface of the server application.

The server application may regularly collect usage reports from all client applications supported by the ISP. These usage reports contain the usage data collected by each client application. This will typically be either click-stream or URL usage data. This usage data is uploaded by client applications to the click-stream server 19, where it is automatically archived. The server application operating on primary server 13 may provide an interface for extracting such data (e.g. for storage in a data warehouse or for data analysis).

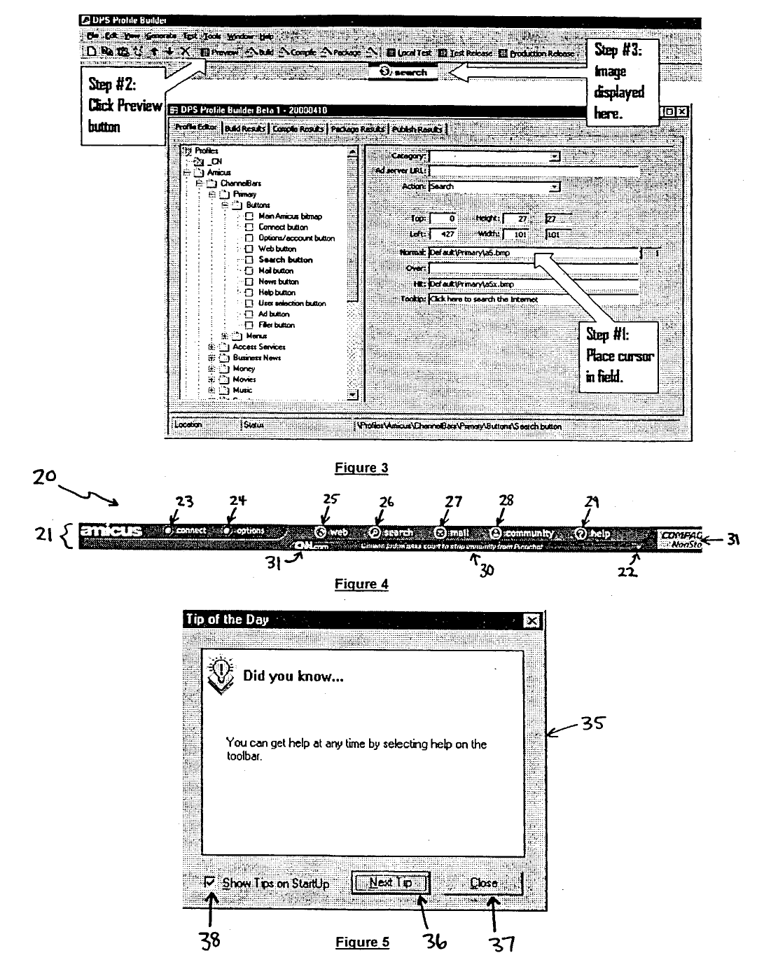

The administration console 14 allows staff of the ISP to update the appearance and behaviour of client applications, such as that operating on client computer 11. New versions of the client application are uploaded to the primary server 13 and can be downloaded automatically by the server program to upgrade the client software. In the present embodiment, the administration console 14 operates under the control of a feature-rich client application which aims to interact seamlessly with the primary server 13. In conjunction with the operations console operating on primary server 13, it can provide ISP staff with a wide variety of tools needed to manage system 10 from the point of view of the primary server 13. FIG. 3 illustrates a user interface of a “profile editor” which may function in this manner on administration console 14.

The user interface allows administrators to view, create, delete and edit a wide range of parameters of the user profile. FIG. 3 shows a modified interface pointing out the three steps required to see a graphic preview of selected bitmaps, buttons, toolbars and even Tooltips. Administrators can preview most graphics and their associated Tooltips using the three preview icons on the left of the Profile Builder toolbar. These icons make it possible to preview graphics in the normal mode, in a ‘mouse-over’ state, and in a ‘mouse-click’ state.

Generally speaking, the administration console 14 can give ISP administrators control of the appearance and behaviour of the client application operating on computing means 11. Using the administration console 14, many aspects of the user interface presented by the client application operating on the client computer 11 can be reconfigured, including graphics, menus, target URLs, configuration and application details.

The ISP administrators can easily create and preview new client application configurations and then release these for testing in a controlled environment. Once a new version of a client application has been fully configured and tested, the administration console 14 manages the release of the new version to the primary server 13. When users of the client application next log in to the ISP, their software can be automatically updated with the new version. This has the potential to be a rapid and painless process.

In a typical case, the process for ISP administrators wishing to create and release new versions of the client application is as follows. Firstly, the ISP administrator edits data in the configurable fields and previews changes. During this process, graphic images and tips can be previewed either separately or as part of the user interface, and local test versions of the client application can be created to test for errors. Secondly, the new version is released for testing. When ready, Administrators release the new version for further testing in a controlled environment. This would typically be the test server 15, situated on a separate computer but still under the control of the ISP. The final stage is production release. Once the new version has been fully tested, it can be released to the primary server 13. Users' client applications automatically identify the new version and can begin to download it. This may be done automatically, or user agreement may be solicited before the download begins.

As well as having preview, local test and remote testing capabilities, the administration console 14 preferably also includes troubleshooting processes for checking through administrative changes step-by-step.

Preferably, the administration console 14 provides a user interface which does not require the administrator to be familiar with the low-level details of the storage format of configuration data such as user profiles. Such embodiments allow use of the administration console 14 by non-technical ISP staff who require only a conceptual view of the system of the present invention, similar to the view of users. As a result, the administration console 14 preferably offers tools for operating at the more abstract level of toolbars, buttons, actions and so forth.

The administration console 14 user interface preferably presents an organised view of the configurable data using a standard tree-style structure. At the top level of this structure are profiles. These may be made available for selection by users of the client application when creating a user profile. Within each profile, ISP administrators can view and edit data across a full range of fields. The administration console toolbar includes handy icons for adding, copying, renaming, removing, cutting and pasting these fields at any level of the “tree” structure, including the top-level Profiles themselves. Drag-and-drop functionality is also supported.

Basic tasks which will typically be performed by ISP administrators in the course of their work with the administration console could include creating new profiles, changing the appearance of a server-defined portion of a user interface, changing the content of user interface menus, including target URLs, and creating new portions of a user interface. From time to time, ISP administrators may also need to perform such tasks as editing ‘Tip of the Day’ Messages, search engine data or other such data which is available for selection by users of the client application.

Where necessary, the administration console allows ISP administrators to broadcast messages to all users, or “narrowcast” messages to a limited audience (e.g. all users with a particular characteristic). Usage data gathering can be enabled or disabled for any and all Profiles. Administrators can also create or edit the categories within which usage data is organised, and assign these categories to individual elements of a user interface. These categories can greatly simplify the process of analysing usage patterns.

The interaction of components of system 10 can also be configured via the administration console 14. ISP administrators can change the default URL addresses of the click-stream server 19, advertising server 18, test server 15 and/or backup server 16, plus default paths for images and newly-created files.

More advanced tasks, such as configuring or reconfiguring an interval for checling a DUN connection, will seldom be necessary but may also be managed via the administration console.

The primary server 13 may also execute an application for basic server administration tasks, such as performance monitoring and system management, known as an operations console. The operations console may be locally resident on the computers of Service Provider operations staff, and may utilise Microsoft's Internet Information Server 4.0 (IIS) software to access and manipulate data. An alternative set-up running Apache web server software on a Solaris server may also be used. The features offered are very similar and include the following primary functions: performance monitoring, error logging, system management, and reporting.

In more detail, performance monitoring may be performed as follows. The operations console may provides a GUI interface for viewing performance data, obtained from primary server 13. All monitoring is done ‘live’ and does not require the server application executed on primary server 13 to be taken offline. ISP staff can configure the frequency with which the data is refreshed from the primary server 13 (for example, every 10 seconds, or every 10 minutes). For example, the operations console may monitor a load, including monitoring aspects such as total number of active user profiles, concurrent active user profiles, total active user accounts, and concurrent active user accounts. The operations console may monitor an activity profile, including monitoring aspects such as a number of new user profiles created, a number of failed/successful authentications, and a number of client application updates. Additionally, the operations console may monitor resource usage, including monitoring aspects such as bandwidth usage, disk usage, memory usage, and system resource usage (for example, usage of file handles, network sockets, etc.).

The operations console may also provide an error logging capability. For example, in the present embodiment, the operations console provides an interface for viewing server application error logs. ISP staff may also configure server application logging options, such as the logging level, emergency notification details (such as a pager number, or e-mail address) and the maximum log size, without needing to take the primary server 13 offline.

The operations console may also provide control of the server application to keep load at a manageable level. The server application operation can be limited to only provide certain levels of service by turning off client application update functionality during peak load times, and/or by turning off collection of usage information by type (for example, continue logging URLs visited but stop logging the launch of local applications). Activities such as messaging, which can imply a ‘burst’ effect on load, can also be configured to take place at a certain ‘throttled’ limit For example, a system message can be sent to no more than 500 users per minute, to reduce the effect on bandwidth utilisation.

Preferably the operations console also enables ISP staff to generate sophisticated reports on customer usage patterns, system performance and availability. For example, a regular report might show the customer usage patterns over a given time period. This report would give the Service Provider useful insights into their customer's behaviour and enable them to better streamline their service to cope with peak access periods.

The nature of the client application of the present embodiment will now be described in more detail.

FIG. 4 illustrates a primary toolbar 21 of a user interface 20 presented by a client application in accordance with the present invention. The embodiment shown is a sample default configuration, which administrators will of course be able to change using the administration console.

The client application presents a user interface 20 which appears in the form of a horizontal toolbar with a range of buttons providing access to various sites, services and products. The toolbar is designed to complement and enhance the experience offered by simple Internet browsers. The client application supports multiple users over a single dial-up connection to the Service Provider. Each user can have multiple user profiles, and users can switch between user profiles by clicking an appropriate icon.

In the present embodiment, the primary toolbar 21 remains basically the same at all times, offering users easy access to preferred applications for web browsers, email, newsgroups and search engines. Start-up, display and connection options are also easily configurable and comprehensive help files and tips are included, as discussed further in the following.

Users can also switch between a range of secondary toolbars (not shown in FIG. 4). Different secondary toolbars may provide access to different sites, services and products. New user profiles may be easily created by choosing a user name and selecting a profile from a dropdown list. Profiles are configured on the server side by the Service Provider, and can be considered a part of the user profile.

Profiles control the appearance and content of the secondary toolbars available to each user. They can be configured to target a specific group of users with a tailored range of content and services. For example, a musician profile might provide a set of music-oriented secondary toolbars that provide access to popular Internet music sites, plus a range of music-related products, software. and services, with special discounts provided via the Service Provider.

Functions that the client application of the present embodiment may perform as an item of application software residing on a user's computer system will now be described.

In the present description, where the terminology employed is that normally applied to the Microsoft Windows Operating System and its associated Internet applications, it is to be understood that the present invention is equally applicable to other operating system environments, particularly Mac OS.

Further, as discussed previously, the present invention has application across a wide range of client computer types, including for example the following operating systems: Windows 95, 98, NT, 2000; Apple MAC 8.0, 8.6, 9.0 (G4); Linux; Unix; Palm; CE; etc. The client application may also support the following: Speech recognition software e.g. Dragon, Naturally Speaking, etc; 24 colours, 256 colours or more; 8-bit or 24-bit colour; all screen resolutions; client launch time under three seconds; client shutdown time under one second; connection via dial-up modem, cable, ADSL or satellite; available via plug-in.

To assist in installing the client application on a user's computer, the client application installer preferably contains a ‘wizard’ to guide users through the installation process. During installation, users will typically: choose a name and path for the install directory; be given the option to create an administrator password (this will be required for any further user creation/deletion/modification); create an initial user profile; and choose whether or not they wish to create other user profiles during installation.

The installation process preferably detects whether certain applications for email, newsgroups and web browsers are installed on the user's computer. Such applications could include web browsers such as Netscape and Internet Explorer; newsreaders such as Outlook Express and Netscape Newswatcher; email applications such as Outlook Express, Eudora Email and MS Outlook; and chat applications such as ICQ and popular IRC clients. The client application may also install a default list of URLs for selectable search engines.

The default DUN connection file would typically be that normally created (or identified) by the ISP Installation Kit Where no such DUN connection file exists, the Installation Wizard preferably prompts the user to select or create a new DUN connection. Note that the ISP will also be able to reconfigure default values later using the administration console software.

It shall be possible to uninstall the client application by running an uninstall executable file which will guide users through the uninstall process. Users shall be given the option of whether to remove the software installation alone, or the user profile details as well. Users shall have to confirm their agreement to proceed before files are deleted. It shall be possible to abort the uninstall process at any time by clicking cancel.

It shall be possible to launch the client application by any of the following methods: double clicking on a short-cut Icon which may be created on the user's desktop during installation; selection of the client application from the Programs group on the Start menu (in MS Windows); an automatic process at computer start-up, provided the Auto Start option has been selected in Start Up preferences of the client application (typically a default option); an automated process when the user initiates a dial-up connection to the Internet, provided an auto-connect option has been selected in Start Up preferences; and double-clicking the application icon in the Explorer window.

An icon indicating that the client application is running on a users computer preferably appears in the Windows Systray whenever the application is running. A submenu may be made accessible from the Systray by right-clicking on the icon. The menu can contain the following functions: Open—to cause the user interface to appear in non auto-hide fashion; Web—to replicate the functionality of the web button on the primary toolbar; Email—to replicate the functionality of the email button on the primary toolbar; Help—to display a Help window in HTML.

The user interface will typically appear horizontally on the user's display. For Windows users, it shall normally appear either at the top or the bottom of the screen, depending where the Windows Taskbar is displayed. It may be possible to move the user interface between the top and bottom of the screen by clicking on the Windows Taskbar and dragging it to the top or bottom of the screen, causing the user interface to automatically switch to the opposite side. The user interface may also support “tearoff” functionality, whereby it can be fixed in place at either the top or bottom of the screen but can be dragged elsewhere on the desktop. In this state it shall appear as a floating palette. When the computer is re-started, the Windows Taskbar and the user interface shall retain their last position unless this option has been disabled.

It will preferably be possible to configure the user interface to either remain visible at all times or retract out of sight when not in use (“auto-hide”). When not visible on the desktop, a cursor movement within the active area at the top or bottom of the screen shall trigger the re-appearance of the user interface. This function may be enabled or disabled by selecting or deselecting an Auto Hide option. Where Auto Hide has been selected, an Always On Top option may be automatically selected as well. In this case, Users shall not be able to de-select Always On Top until Auto Hide has been disabled.

The client application may also provide a mouse-over function, in which icons and buttons of the user interface are able to alter appearance as the mouse cursor is moved across them, and again when the image is clicked. ISP Administrators may be able to configure this function using the Administration Console and disable it when not required. Users may also be able to view Tool Tips by holding their mouse cursor over any of the selectable features on the user interface.

Considering FIG. 4 more closely, it can be seen that the primary toolbar includes a connect button 23, an options button 24, a web button 25, a search button 26, a mail button 27, a community button 28, a help button 29, a media news ticker 30 with dropdown menu 22 of news providers, and advertising fields 31. The user interface may further include text entry fields, an incentive points ticker, and an HTML display. It is to be noted that, in the present embodiment of the invention, the primary toolbar is configurable, with FIG. 4 indicating what might be found in a typical primary toolbar. Details of these features are discussed further in the following. Where any of the primary toolbar or submenu items link to a web URL, the client application shall automatically launch the user's preferred web browser with the targeted URL address. The client application in the present embodiment thereafter relies on these applications to manage the Internet connection thereafter. Where the item points to another application, such as email or a newsgroups reader, the client application shall automatically launch that application. Users shall have the option of configuring these applications to either automatically launch in a new application window, or to use windows that are already open on the desktop.

FIG. 5 illustrates a tips frame 35 appearing on a display of a user's computer upon start-up of a client application in accordance with the present invention. Users shall be able to view further tips by clicking the next tip button 36. The window shall be closed by clicking the close button 37. Users shall be able to disable further appearances of this window by deselecting the Show Tips on Start Up box 38. Showing Tips on Start Up will typically be the default option. Windows users may also be able to access Tip Of The Day messages by clicking Help and selecting Tips.

The client application preferably also contains a comprehensive list of Error Messages, to appear in response to exceptions resulting from user or system errors.

FIG. 6 illustrates a first submenu 40 of the primary toolbar 21 of the user interface 20 of FIG. 5. Clicking the connect icon 23 of user interface 20 shall cause a submenu 40 to appear with a list of User Profiles configured for use. Selecting any of the configured User Profiles shall cause a login window 50 to appear as shown in FIG. 7, which illustrates a login procedure performed by the client application. Entering a correct Username and Password and clicking the OK button 51 shall cause the selected user profile to become active (causing available secondary toolbars and preferred helper applications to be those configured for that user profile), and, if the auto-connect system setting is enabled, and if the user is not already connected, the client application shall connect the user to the Internet using the preferred dial up connection. Once the user is connected, the Connect button 23 may change to Disconnect Users shall then be able to disconnect from the Internet by clicking the Disconnect button. In the event of a disconnection from the ISP service that has not been initiated by the user, the client application shall manage reconnection by notifying the user and requesting confirmation to resume the connection.

Where users are connected over a LAN connection, a connect button may not be necessary. When the computer shuts down or the client application closes, the last user shall be automatically logged out. Connection via methods other than dialup (e.g. cable, satellite or ADSL) may be made available via optional plug-ins to the client application.

FIG. 8 illustrates a second submenu 60 of the primary toolbar 21 of the user interface 20 of FIG. 5, which appears when the Options icon is clicked. Selecting Change Active User in submenu 60 shall cause a submenu 61 of available user profiles to be displayed. Selecting a new User Profile from this submenu shall cause the Login Window to appear (as shown in FIG. 7).

FIG. 9 illustrates a third submenu 70 of the primary toolbar 21 of the user interface of FIG. 5, which appears when the web button 25 is clicked. Selecting any of the displayed items shall launch the user's preferred web browser, with a target URL (configured by the ISP) appropriate to the displayed item.

Clicking the Search icon 26 on the Primary toolbar 21 shall cause a window 80 to appear as shown in FIG. 10. Users shall be able to search the Web using their preferred search engine by entering text in the Search For: field 81 and clicking the OK button 82. This shall cause the user's selected search engine to run a search for the specified text within the preferred web browser. Depending on user options, the web browser may be launched if not already open, or the search may be displayed in a new browser window. A dropdown menu 83 of available search engines shall be displayed by clicking the Using: dropdown arrow on the right. Users shall be able to switch between search engines by selecting a new search engine from this list.

FIG. 11 illustrates a fourth submenu 90 of the primary toolbar 21 of the user interface 20 of FIG. 5, which appears when the mail button 27 is clicked, enabling users to open their selected email account using their preferred mail program. Selecting one of these accounts shall launch the user's preferred email application with configuration details (e.g. POP server) appropriate to that account. The client application shall alert the user when new mail is waiting in any of his/her accounts. When new mail is waiting, the mail icon on the primary toolbar shall change colour or otherwise alter appearance to alert the user (the preferred image change can be configured by the ISP using the Administration Console).

FIG. 12 illustrates a fifth submenu 100 of the primary toolbar 21 of the user interface 20 of FIG. 5, which appears when the community button 28 is clicked. Clicking on any of the Top 10 selections shall cause a submenu of Top 10 items to appear (e.g. Top 10 MP3s=No. 1 “Happy Hippy” by Neil Young, No. 2 “Times Changed” by Bob Dylan, etc.). Clicking on any of these items shall launch the preferred web browser with an appropriate target URL. Clicking the Launch Amigos item shall launch the Amigos feature (described below).

FIG. 13 illustrates a sixth submenu 110 of the primary toolbar of the user interface of FIG. 5, which appears when the help button 29 is clicked. These items may be changed according to the ISP's desires, but clicking on the menu items might have the following effects: Internet Tips and Tricks—display of a helpful Tips and Tricks window in the User's preferred browser; Online Manual—display of the Help Contents window in the user's preferred browser; View FAQ Pages—display of the FAQ window in the User's preferred browser; About—appearance of a window with client application product information.

FIG. 14 illustrates the news ticker 30 of the primary toolbar 21 of the user interface 20 of FIG. 5. News items shall be displayed one at a time, scrolling horizontally from right to left at a readable pace, with a pause between each item. Clicking the dropdown arrow icon 22 at the end of the News Ticker shall display a dropdown menu 130 with a list of News Providers, as configured by the ISP, and as shown in FIG. 15. Users shall be able to switch between news providers by selecting an alternative news provider from this list.

The primary toolbar may further include icons such as Shopping, Messaging, and Newsgroups, briefly described here. Clicking the Shopping icon shall cause a submenu to appear with various Shopping options (e.g. CD Now, Net Credit Points, etc.). Selecting any of these options shall take the user to a corresponding URL. Clicking the Messaging icon on the user interface shall cause a submenu to appear with the options and functions such as: SMS messages—to link to an SMS message portal (possibly brought up in a client application window rather than a browser); Email—to launch the User's designated Email program. Selecting Newsgroups may either bring up a submenu of available newsgroups, or launch the user's preferred newsgroups reader, possibly with a designated target URL.

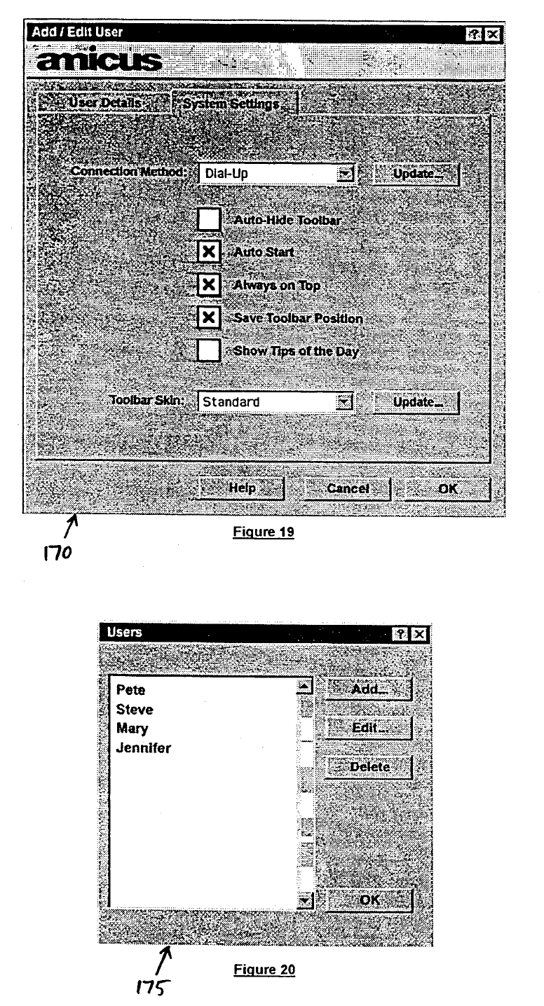

FIG. 16 illustrates the primary toolbar 21 of FIG. 5 and a secondary toolbar 140 of the user interface 20, presented by the client application. Secondary toolbars will typically be theme-oriented (e.g. Sport) and contain a range of click-able icons (e.g. Tennis, Golf, Football . . . ) which display dropdown menus linked to specific URLs (e.g. Tennis News, Tennis Results, Tennis Rankings . . . ). Using the administration console of the ISP, it will be possible for the ISP to closely define the range and behaviour of secondary bars, their icons and menus. Whenever an active user profile has been selected, a secondary toolbar 140 shall appear just below the primary bar 21 as shown in FIG. 16. The secondary toolbar 140 displays content features customised to the active user profile. Clicking the dropdown arrow icon 141 on the right shall display a submenu 150 of all secondary bars available to the active user profile as shown in FIG. 17.

Users shall be able to edit their details and select preferred applications from the user details window as follows: firstly, click the options button 24 on the primary toolbar as shown in FIG. 8; secondly, select Toolbar Settings; and thirdly, click on the User Details tab. FIG. 18 illustrates a frame 160 of the user interface which will then appear for editing characteristics of the user profile.

Users shall be able to edit details of their User Profile as follows: Name—enter a User Profile name in the text field; Age—select an age-range from the dropdown list; Gender—select male or female from the dropdown list; Email—enter a valid email address in the text field; Picture—right-click the photo to select a path to your preferred image (for example in Bitmap Format).

Changes to user details shall be saved by clicking OK. Users shall be able to abort any changes by pressing Cancel. Help with these features shall be available by clicking Help.

Each user shall be able to select which helper applications they wish to use with their user profile. These preferences shall be unique to that user profile; changing from one user profile to another shall cause the helper applications details to alter accordingly.

A variety of configurable options shall be accessible from the System Settings window as follows: click the options button on the primary bar; select Toolbar Settings; and click on the System Settings tab. A window 170 shall appear as shown in FIG. 19. Users shall be able to configure the following: select or update connection method; auto hide; auto start; always on top; save toolbar position; show tips of the day; select or update toolbar skin.

In more detail, users shall choose their preferred connection method by selecting from a drop down list. Changes to the connection method can be made by choosing from the combination box provided, or clicking “Update . . . ” to download new connection method modules from their ISP. Help with this feature shall be accessible by clicking the Help button. Note that separate connection methods are treated as “Plug-ins” to the client application core.

Users shall be able to configure a variety of features by selecting start up from the options window and then placing a tick in the checkbox of the desired feature. Available features shall be as follows: Auto Connect connects the User to their ISP whenever the client application is started; Auto-Hide Toolbar—hides the user interface when not in use; Always On Top—causes the client application to always be displayed on top of other applications (see above); Show Tips of the Day—displays a Tip of the Day message whenever the client application is started. Help with these features shall be accessible by clicking the Help button. Clicking OK shall save the changes and close the System Settings window. Clicking Cancel shall close the window without saving changes.

Users will be able to change the user interface appearance using a range of skins. These will typically be theme-oriented e.g. Star Wars skin, Cindy Crawford skin, etc. The client application shall be installed using a standard suite of 3-4 skins. Users shall be able to select from a range of alternative skins by clicking the dropdown arrow on the right of the Skin field. The dropdown list of available skins shall be updated by clicking Update. Help with this feature shall be accessible by clicking the Help button. Clicking OK shall save the changes and close the System Settings window. Clicking Cancel shall close the window without saving changes.

User profiles can be created, edited and deleted by clicking the options icon on the primary toolbar and selecting Add/Edit Users. The window 175 shown in FIG. 20 shall appear. New user profiles may be created by clicking the Add . . . button, entering the required details and clicking OK. Current users shall be edited by selecting a user profile from the displayed list and clicking Edit This shall display details of the selected user profile such as the name and selected profile. Changes shall be made by editing these fields and clicking OK. Current users shall be deleted by selecting a user profile from the displayed list and clicking Delete. Adding and deleting users may be restricted to some kind of “Admin” status, protected by a username & password e.g. Administrator Password. This would typically be defined at the installation stage of the client application.

The client application preferably uses a platform-independent core and supports multiple plug-ins. While all but the most elementary functions can actually be developed as plug-ins, it is expected that most of the functions specified in the above will be included in the basic client application product installed to a user's computer. Nevertheless, a range of plug-ins available to download on request may be desirable.

FIG. 21 illustrates a plug-in chat application supported by some embodiments of the invention, known as Amigos. Selecting Launch Amigos from the community dropdown menu shall cause the Amigos main window to appear, as shown in FIG. 21. Clicking on any of the Amigos' names shall cause a separate Amigos chat screen to appear as shown above right (Jodie). Clicking the dropdown arrow icon in the Amigos window shall display other criteria for displaying Amigos names available for chat. These would typically include the following: Friends—this shall display a user-defined list of “friends” who are using a similar version client application with the same ISP (as shown above); Website—this shall display a list of other users with a similar version of the client application and with the same ISP who are currently at the same website as the active user; Secondary Bar—this shall display a list of other users who have the same Secondary Bar currently displayed.

FIG. 22 illustrates a plug-in online wallet application supported by some embodiments of the invention. The electronic online wallet named Paymate shall launch automatically whenever it detects an internet form in a users browser. Users shall be able to configure the details of the cards. available in their wallet They shall then be able to drag the desired credit card graphic from the wallet and dropped it into the browser window. This shall automatically populate the displayed form with the relevant card details.

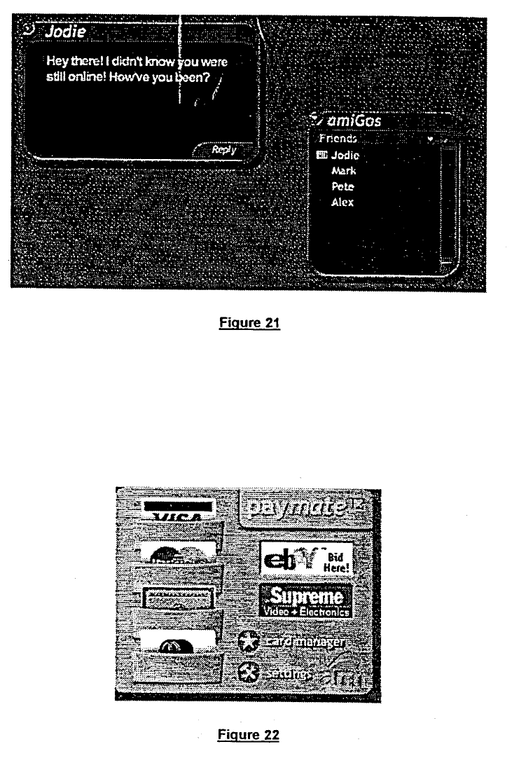

FIG. 23 illustrates a plug-in media player application supported by some embodiments of the invention. The Mediaplayer shall allow the client application to display streaming video and audio launched directly from the toolbar. It shall be automatically launched when such files are selected. Standard media-playing functions shall be available via graphic buttons such as: Play, Stop, Pause, Next track, Last track The Mediaplayer window shall display a list of media files down the right-hand side of the screen. These will typically be updated dynamically by the ISP and feature the latest releases. The Mediaplayer preferably supports the latest streaming media technologies, including QuickTime, Real, Flash etc.

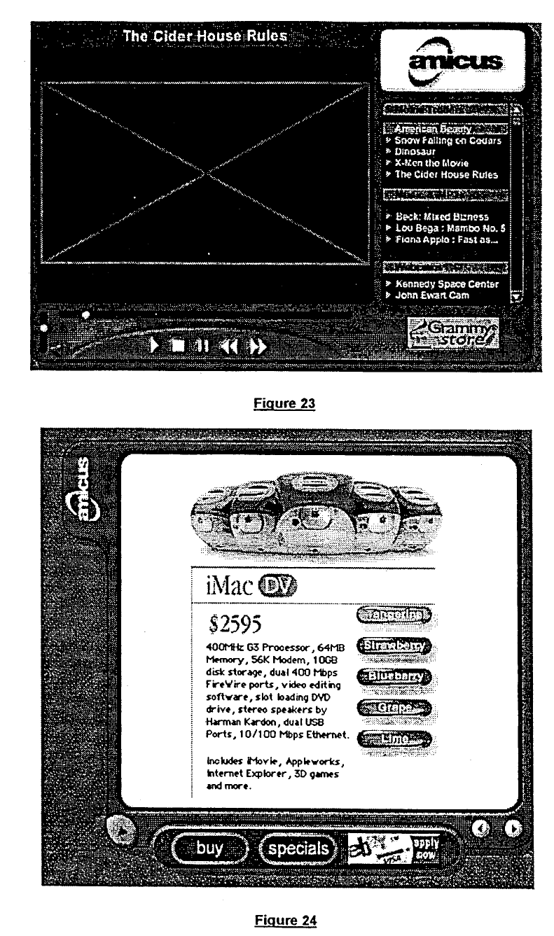

FIG. 24 illustrates an embodiment of the invention in which the client application provides browser capability. The present client application shall be able to display HTML content by way of expandable “tabs” which appear directly on the desktop. Buttons outside the HTML window shall also be controlled through HTML (including ad serving) as well as standard browser navigation arrows.

Preferably, it shall be possible for users to switch between dialup connection and other connection types—e.g. satellite, adsl or cable—using a Connection Method plug-in. Further the client application is preferably generally designed to behave in a manner which is typical of the Operating System on which it is installed. This will apply to all standard functions such as basic mouse movements, clicking and so forth.

The ISP shall be able to easily update aspects of the user interface appearance, content and software functionality, creating new configuration data (contents and appearance) or new software application data on the server side. A version definition shall be associated with each release, including the default installation configuration.

The client application and server application shall exchange data each time the user logs in, in the process of which the version numbers shall be checked. If a newer version is available, users shall either download it automatically or—depending on server-side configurations, be prompted to download it. If users elect not to download the new version immediately, they shall be prompted again each time they log in.

The client application is also preferably configured (on the server side) to seamlessly record each instance of a user click on selectable elements of the user interface. This data shall be batched locally and uploaded to a Click-stream server (see FIG. 1) at convenient times, providing the ISP with valuable information usage patterns.

As will be appreciated, the present embodiment provides a user interface which is easily reconfigurable. An icon which displays a dropdown menu today can be reconfigured to launch a web browser tomorrow. The system, applications and methods of the present invention will preferably simplify the customer's experience of the Internet, enhance the customer's experience of the Internet by providing easy access to rich, customised content, raise the Service Provider's visibility to customers by providing a branded desktop portal with access to ISP-defined content, and increase Service Provider revenue by improving value-added services, content and advertising space, improving customer retention and reducing support costs.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for providing user access to a network, including:
client computing means executing a resident client application, the client application presenting a user interface facilitating browser access to a plurality of network sites, the user interface being presented in accordance with a user profile which defines characteristics of the user interface; and
server computing means executing a resident server application, the server application operable to communicate with the client application, to store the user profile, to alter the user profile, and to communicate the user profile and alterations of the user profile to the client application.

2. A system as claimed in claim 1 wherein said network is the internet.

3. A system as claimed in claim 2 wherein said server computing means is provided by an Internet Service Provider which connects said client computing means to the internet

4. A system as claimed in any preceding claim wherein the client application is operable to undertake click-stream analysis of use of the user interface.

5. A system as claimed in any preceding claim wherein the server application is operable to undertake click-stream analysis of use of the user interface.

6. A system as claimed in any preceding claim wherein the client application is operable to present a first user interface of a plurality of user interfaces based on a corresponding one of a plurality of user profiles.

7. A system as claimed in claim 6 wherein said first user interface is dependent on a current user's identity.

8. A system as claimed in claim 7 wherein the client application is operable to perform a routine login procedure to establish the current user's identity.

9. A system as claimed in claim 6 wherein said first user interface is dependent on a current date.

10. A system as claimed in any preceding claim wherein the user profile includes user-defined portions and server-defined portions.

11. A system as claimed in any preceding claim wherein the server application is operable to store a plurality of user profiles.

12. A system as claimed in claim 11 wherein the server application is operable to analyse the plurality of user profiles and to define a characteristic of a first user profile by analysis of a corresponding characteristic of each of the plurality of user profiles.

13. A system as claimed in any preceding claim wherein the user profile defines visible attributes of the user interface.

14. A system as claimed in any preceding claim wherein the user profile defines functional attributes defining a manner of operation of the client application in presenting the user interface.

15. A system as claimed in any preceding claim wherein the client application is operable to cooperate with a network browser to present network content to a user.

16. A system as claimed in any preceding claim wherein alterations of the user profile are communicated to the client application upon completion of the alterations.

17. A system as claimed in any preceding claim wherein the client application is operable to provide user access to more than one network.

18. A system as claimed in any preceding claim wherein the server application is operable to perform one or more of the following: provide authentication and session management services to one or more client applications; provide messaging to one or more client applications; communicate an updated client application to replace an existing client application; export collected usage data to warehousing facilities; and provide industry standard interfaces for operational monitoring and management

19. A client application for residing on client computing means and for providing user access to a network,
wherein the client application is operable to receive a user profile which is stored by a server application and which defines characteristics of a user interface,
wherein the client application is operable to receive alterations of the user profile,
and wherein the client application is operable to present the user interface in accordance with the user profile, the user interface facilitating browser access to a plurality of network sites.

20. A client application as claimed in claim 19 wherein said network is the internet

21. A client application as claimed in claim 19 or claim 20 wherein the client application is operable to undertake click stream analysis of use of the user interface.

22. A client application as claimed in any one of claims 19 to 21 wherein the client application is operable to present a first user interface of a plurality of user interfaces based on a corresponding one of a plurality of user profiles.

23. A client application as claimed in claim 22 wherein said first user interface is dependent on a current user's identity.

24. A client application as claimed in claim 23 wherein the client application is operable to perform a routine login procedure to establish the current user's identity.

25. A client application as claimed in claim 22 wherein said first user interface is dependent on a current date.

26. A client application as claimed in any one of claims 19 to 25 wherein the user profile includes user-defined portions and server-defined portions.

27. A client application as claimed in any one of claims 19 to 26 wherein the user profile defines visible attributes of the user interface.

28. A client application as claimed in any one of claims 19 to 27 wherein the user profile defines functional attributes defining a manner of operation of the client application in presenting the user interface.

29. A client application as claimed in any one of claims 19 to 28 wherein the client application is operable to cooperate with a network browser to present network content to a user.

30. A client application as claimed in any one of claims 19 to 29 wherein alterations of the user profile are communicated to the client application upon completion of the alterations.

31. A client application as claimed in any one of claims 19 to 30 wherein the client application is operable to provide user access to more than one network

32. A server application for residing on server computing means and for facilitating user access to a network,
wherein the server application is operable to store a user profile defining characteristics of a user interface, the user interface facilitating browser access to a plurality of network sites,
wherein the server application is operable to alter the user profile, and
wherein the server application is operable to communicate the user profile and alterations of the user profile to a client application resident on and executed by client computing means, for presentation of the user interface by the client application.

33. A server application as claimed in claim 32 wherein said network is the internet.

34. A server application as claimed in claim 33 wherein said server application is provided by an Internet Service Provider which connects said client application to the internet.

35. A server application as claimed in any one of claims 32 to 34 wherein the server application is operable to undertake click-stream analysis of use of the user interface.

36. A server application as claimed in any one of claims 32 to 35 wherein the user profile includes user-defined portions and server-defined portions.

37. A server application as claimed in any one of claims 32 to 36 wherein the server application is operable to store a plurality of user profiles.

38. A server application as claimed in claim 37 wherein the server application is operable to determine a user profile to be communicated to a client application based on a current user's identity.

39. A server application as claimed in any one of claims 32 to 38 wherein the server application is operable to perform a routine login procedure to establish a current user's identity.

40. A server application as claimed in claim 37 or 38 wherein the server application is operable to analyse the plurality of user profiles and to define a characteristic of a first user profile by analysis of a corresponding characteristic of each of the plurality of user profiles.

41. A server application as claimed in any one of claims 32 to 40 wherein the user profile defines visible attributes of the user interface.

42. A server application as claimed in any one of claims 32 to 41 wherein the user profile defines functional attributes defining a manner of operation of the client application in presenting the user interface.

43. A server application as claimed in any one of claims 32 to 42 wherein the server application is operable to communicate alterations of the user profile to the client application upon completion of the alterations.

44. A server application as claimed in any one of claims 32 to 43 wherein the server application is operable to perform one or more of the following:
provide authentication and session management services to one or more client applications; provide messaging to one or more client applications;
communicate an updated client application to replace an existing client application; export collected usage data to warehousing facilities; and provide industry standard interfaces for operational monitoring and management

45. A method for providing user access to a network, including the steps of:
receiving at a client site a user profile which defines characteristics of a user interface;
presenting at the client site a user interface in accordance with the user profile, the user interface facilitating browser access to a plurality of network sites;
storing the user profile at a server site;
altering the user profile at the server site; and
communicating the user profile and alterations of the user profile to the client site.

46. The method of claim 45 further including the step of performing, at the server site, click-stream analysis of use of the user interface.

47. The method of claim 45 or claim 46 wherein the step of presenting includes presenting one of a plurality of user interfaces based on a corresponding one of a plurality of user profiles.

48. The method of claim 47, further including the step of establishing a current user's identity.

49. The method of claim 48 wherein the current user's identity is established by a login procedure.

50. The method of any one of claims 45 to 49 wherein the step of storing includes storing a plurality of user profiles.

51. The method of claim 50 including the further step of defining a characteristic of a first user profile by analysis of a corresponding characteristic of each of the plurality of user profiles.

52. The method of any one of claims 45 to 51 wherein the step of communicating alterations of the user profile is performed upon completion of said alterations.

53. The method of any one of claims 45 to 52 wherein the step of communicating alterations of the user profile is performed upon establishment of network access by a user.

54. The method of any one of claims 45 to 53, further including one or more of the following steps:
providing authentication and session management services to one or more client applications;
providing messaging to one or more client applications;
communicating an updated client application to replace an existing client application;
exporting collected usage data to warehousing facilities; and
providing industry standard interfaces for operational monitoring and management.

55. A method of providing user access to a network at a client site, including the steps of:
receiving at the client site a user profile which defines characteristics of a user interface and which is stored at a server site;
receiving at the client site alterations of the user profile; and
presenting a user interface in accordance with the user profile, the user interface facilitating browser access to a plurality of network sites.

56. The method of claim 55 wherein the step of presenting includes presenting one of a plurality of user interfaces based on a corresponding one of a plurality of user profiles.

57. The method of claim 56 wherein the step of presenting is dependent upon a current user's identity.

58. The method of any one of claims 55 to 57 including the further step of establishing a current user's identity.

59. A method of facilitating, from a server site, user access to a network, the method including the steps of:
storing at the server site a user profile defining characteristics of a user interface, the user interface facilitating browser access to a plurality of network sites;
altering the user profile; and
communicating the user profile and alterations of the user profile to a client site for presentation of the user interface.

60. The method of claim 59 further including the step of performing, at the server site, click-stream analysis of use of the user interface.

61. The method of claim 59 or 60 further including the step of establishing a current user's identity.

62. The method of any one of claims 59 to 61 wherein the step of storing includes storing a plurality of user profiles.

63. The method of claim 62 further including the step of defining a characteristic of a first user profile by analysis of a corresponding characteristic of each of the plurality of user profiles.

64. The method of any one of claims 59 to 63 wherein the step of communicating alterations of the user profile is performed upon completion of said alterations.

65. The method of any one of claims 59 to 64 wherein the step of communicating alterations of the user profile is performed upon establishment of network access by a user.

66. The method of any one of claims 59 to 65 further including one or more of the following steps:
providing authentication and session management services to one or more client applications;
providing messaging to one or more client applications;
communicating an updated client application to replace an existing client application;
exporting collected usage data to warehousing facilities; and
providing industry standard interfaces for operational monitoring and management.

67. A storage medium storing in machine-readable form the client application of any one of claims 19 to 31.

68. A storage medium storing in machine-readable form the server application of any one of claims 32 to 44.

69. A computing means operating under the control of the client application of any one of claims 19 to 31.

70. A computing means operating under the control of the server application of any one of claims 32 to 44.

71. A system for providing user access to a network, comprising:
client computing means executing a resident client application, the client application presenting a user interface, the user interface operable to facilitate non-browser access to a plurality of network sites and to facilitate browser access to a plurality of network sites, the user interface being presented in accordance with a user profile which defines characteristics of the user interface; and
server computing means executing a resident server application, the server application operable to communicate with the client application, to store the user profile, to alter the user profile, and to communicate the user profile and alterations of the user profile to the client application.

72. A client application for residing on client computing means and for facilitating user access to a network,
wherein the client application is operable to receive a user profile which is stored by a server application and which defines characteristics of a user interface,
wherein the client application is operable to receive alterations of the user profile,
and wherein the client application is operable to present the user interface in accordance with the user profile, the user interface facilitating non-browser access to a plurality of network sites, and facilitating browser access to a plurality of network sites.

73. A server application for residing on server computing means and for facilitating user access to a network,
wherein the server application is operable to store a user profile defining characteristics of a user interface, the user interface facilitating non-browser access to a plurality of network sites and facilitating browser access to a plurality of network sites,
wherein the server application is operable to alter the user profile, and
wherein the server application is operable to communicate the user profile and alterations of the user profile to a client application resident on and executed by client computing means, for presentation of the user interface by the client application.
